(19) United States
(12) Patent Application Publication
(10) Pub. No.: US 2011/0290528 A1
(43) Pub. Date: Dec. 1, 2011

(54) Insulating varnish and insulated wire formed by using the same

(75) Inventors: Yuki Honda, Hitachi (JP); Tomiya Abe, Hitachi (JP); Shuta Nabeshima, Hitachi (JP); Hideyuki Kikuchi, Hitachi (JP)

(73) Assignee: Hitachi Cable, Ltd., Tokyo (JP)

(21) Appl. No.: 13/067,054

(22) Filed: May 4, 2011

(30) Foreign Application Priority Data
May 31, 2010 (JP) 2010-124591

(51) Int. Cl. H01B 7/00; H01B 3/30; C08K 5/1535

(52) U.S. Cl. 174/119 C; 524/111; 174/110 SR

(57) ABSTRACT

An insulating varnish includes a polyamide-imide resin varnish including a solvent and a polyamide-imide resin, and an organosol. The polyamide-imide resin varnish is obtained by a synthesis reaction between a resin component (X) and an isocyanate component (Y). The resin component (X) is obtained by a synthesis reaction between a diamine component and an acid component in presence of an azeotropic medium. The diamine component includes aromatic diamines including a divalent aromatic group having three or more aromatic rings. The isocyanate component (Y) includes a diisocyanate (Y1) a molecule of which includes a bend structure.

The present application is based on Japanese patent application No. 2010-124591 filed May 31, 2010, the entire contents of which are incorporated herein by reference.

### BACKGROUND OF THE INVENTION

1. Field of the Invention

The present invention relates to an insulating varnish and an insulated wire formed by using the insulating varnish and, in particular, to an insulating varnish suitable for a coil of electric equipment such as a motor and a transformer, and an insulated wire formed by using the insulating varnish.

2. Description of the Related Art

Generally, as a coil of electric equipment such as a rotating electrical machine and a transformer, an insulated wire (an enamel wire) is used widely that has a metallic conductor (conductor) and an insulation coating layer around the metallic conductor, the metallic conductor having a cross-section (e.g., round or rectangular cross section) corresponding to the use or shape of the coil, the insulation coating layer being composed of one or more insulating coatings that are obtained by applying and baking an insulating varnish on the metallic conductor, the insulating varnish being prepared by dissolving a resin such as polyimide resin, polyamide-imide resin and polyester-imide resin into an organic solvent.

Electric equipment such as a rotating electrical machine and a transformer has come to be driven by inverter control. When an inverter surge voltage (surge voltage) occurred with the inverter control is high, the inverter surge voltage occurred may intrude into the electric equipment driven by the inverter control. If the inverter surge voltage intrudes into electric equipment in this way, a partial discharge may occur in an insulated wire constituting the coil of the electric equipment because of the inverter surge voltage, thus the insulating coating of the insulated wire may deteriorate and be damaged.

A deterioration of the insulating coating due to the partial discharge occurs at microscopic voids existing in the insulating coating. For example, JP-A-2001-307557 and JP-A-2006-299204 disclose insulated wires whose insulating coating is less subject to deterioration, wherein the insulating coating is formed by applying and baking an insulating varnish on a conductor, the insulating varnish being prepared by, e.g., dispersing into resin varnish fine inorganic particles of silica, alumina, titanium oxide etc. or organosol that is prepared by dispersing the fine inorganic particles into a dispersion medium.

JP-A-2009-161683 discloses another insulated wire for preventing a deterioration of the insulating coating due to inverter surge voltage, wherein the insulating coating is formed by applying and baking a polyamide-imide resin insulating varnish on a conductor, the polyamide-imide resin insulating varnish being prepared by, e.g., mixing an aromatic diisocyanate component having one or two aromatic rings with aromatic imide prepolymer that contains aromatic diamine component having three or more aromatic rings and acid component. JP-A-2009-161683 mentions that the polyamide-imide resin insulating varnish can provide the insulating coating with a low relative dielectric constant and the insulated wire with a high partial discharge inception voltage (PDIV).

### SUMMARY OF THE INVENTION

In recent years, hybrid cars etc. have been popular due to energy saving etc. The electric equipment used for the hybrid cars etc. is inverter-controlled at a higher voltage than ever because it needs to be downsized and driven at a high voltage in order to improve the fuel efficiency and the driving performance of the hybrid cars etc. Accordingly, recent insulated wires need to have a higher partial discharge inception voltage (e.g., 950 V or more) than ever so as to prevent the occurrence of a partial discharge.

Furthermore, the space factor of the insulated wire to a motor recently needs to be increased. However, due to pursuing further downsizing and higher efficiency of the electric equipment inverter-controlled at a high voltage, an inverter surge voltage higher than the high partial discharge inception voltage may occur. Thus, the high inverter surge voltage may cause a partial discharge in the insulated wire to have a dielectric breakdown.

In reply to these requirements, an insulating varnish may be proposed that the organosol disclosed in JP-A-2001-307557 and JP-A-2006-299204 is dispersed in the polyamide-imide resin insulating varnish disclosed in JP-A-2009-161683. However, if the organosol is simply combined with the polyamide-imide resin insulating varnish, the low compatibility between the organosol and the polyamide-imide resin insulating varnish, may cause an increase in relative dielectric constant, aggregation of fine inorganic particles, or the like. Thereby, the partial discharge inception voltage of an insulated wire may decrease, and the insulating coating may deteriorate easily. Namely, the property of the insulating coating rather deteriorates.

Accordingly, it is an object of the invention to provide an insulating varnish that can form an insulating coating that has a high partial discharge inception voltage and is less subject to a dielectric breakdown even if an inverter surge voltage occurs, and to provide an insulated wire formed by using the insulating varnish.

(1) According to one embodiment of the invention, an insulating varnish comprises:

a polyamide-imide resin varnish comprising a solvent and a polyamide-imide resin; and

an organosol,

wherein the polyamide-imide resin varnish is obtained by a synthesis reaction between a resin component (X) and an isocyanate component (Y),

the resin component (X) is obtained by a synthesis reaction between a diamine component and an acid component in presence of an azeotropic medium,

the diamine component comprises aromatic diamines comprising a divalent aromatic group having three or more aromatic rings, and

the isocyanate component (Y) comprises a diisocyanate (Y1) a molecule of which includes a bend structure.

In the above embodiment (1) of the invention, the following modification and change can be made.

(i) The isocyanate component (Y) further comprises a diisocyanate (Y2) a molecule of which includes a straight-chain structure.

(ii) A ratio of the diisocyanate (Y1) to a total of the diisocyanate (Y1) and the diisocyanate (Y2) is in a range of 10 to 90% by mole percent [{Y1/(Y1+Y2)}×100].

(iii) The diisocyanate (Y1) comprises 2,4′-diphenylmethane diisocyanate, 3,4′-diphenylmethane diisocyanate, 3,3′-diphenylmethane diisocyanate, or 2,2′-diphenylmethane diisocyanate, 2,4′-diphenyl ether diisocyanate.

(iv) The polyamide-imide resin varnish is obtained by a synthesis reaction between the resin component (X) and the isocyanate component (Y) comprising 2,4′-diphenylmethane diisocyanate and 4,4′-diphenylmethane diisocyanate, and

the polyamide-imide resin varnish comprises a repeat unit represented by chemical formula (1):

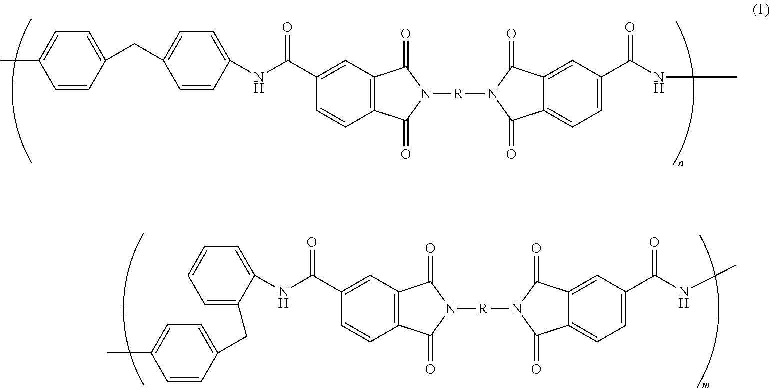

where “R” represents the divalent aromatic group having three or more aromatic rings, and “m” and “n” each represent an integer of 1 to 99.

(v) The aromatic diamines comprise at least one selected from the group consisting of 2,2-bis[4-(4-aminophenoxy)phenyl]propane (BAPP), bis[4-(4-aminophenoxy)phenyl]sulfone, bis[4-(4-aminophenoxy)phenyl]ether, 9,9-bis(4-aminophenyl)fluorene, 4,4′-bis(4-aminophenoxy)biphenyl, 1,4-bis(4-aminophenoxy)benzene, and isomers thereof

(vi) The azeotropic medium comprises xylene.

(vii) 10 to 90 parts by mass of the organosol are included relative to 100 parts by mass of the polyamide-imide resin.

(2) According to another embodiment of the invention, an insulated wire comprises:

a conductor; and

an insulating coating formed by applying and baking the insulating varnish according to the embodiment (1) on the conductor.

In the above embodiment (2) of the invention, the following modification and change can be made.

(viii) The conductor has a rectangular cross section.

Points of the Invention

According to one embodiment of the invention, an insulating varnish is prepared such that an isocyanate component (Y), which is reacted with the resin component (X) in a synthesis reaction (the second synthesis reaction) in order to obtain a polyamide-imide resin varnish contained in the insulating varnish, necessarily includes a diisocyanate (Y1) which includes a bent structure in a molecule thereof. The diisocyanate (Y1) including the bent structure in the molecule comprises preferably a diisocyanate including a divalent aromatic group having two aromatic rings, in order to improve the compatibility with the resin component (X) and the compatibility between the polyamide-imide resin obtained finally and the organosol.

Thus, the insulating varnish can form an insulating coating that has a high partial discharge inception voltage and is less subject to a dielectric breakdown even if an inverter surge voltage occurs, and an insulated wire can be formed by using the insulating varnish.

### BRIEF DESCRIPTION OF THE DRAWINGS

The preferred embodiment according to the invention will be explained below referring to the drawings, wherein:

FIG. 1 is a schematic cross sectional view showing an insulated wire with round cross section in a preferred embodiment according to the invention; and

FIG. 2 is a schematic cross sectional view showing an insulated wire with rectangular cross section in a preferred embodiment according to the invention.

### DETAILED DESCRIPTION OF THE PREFERRED EMBODIMENTS

The preferred embodiments of an insulating vanish and an insulated wire of the invention will be described below.

Insulating Varnish

An insulating varnish in the embodiment of the invention is prepared by mixing a polyamide-imide resin varnish with an organosol. The polyamide-imide resin varnish comprises a solvent and a polyamide-imide resin. The polyamide-imide resin varnish is obtained by a synthesis reaction between a resin component (X) and an isocyanate component (Y). The resin component (X) is obtained by a synthesis reaction between a diamine component and an acid component in presence of an azeotropic medium. The diamine component comprises aromatic diamines that have a divalent aromatic group having three or more aromatic rings. The isocyanate component (Y) contains a diisocyanate (Y1) the molecule of which contains a bend structure.

In other words, the insulating varnish in the embodiment of the invention contains the polyamide-imide resin insulating varnish obtained by the synthesis reaction between the resin component (X) and the isocyanate component (Y). Here, if the polyamide-imide resin is obtained efficiently, a mixture ratio of the resin component (X) and the isocyanate component (Y) is not especially limited. Hereinafter, the resin component (X) and the isocyanate component (Y) are concretely described.

Synthesis of Resin Component (X)

The resin component (X) is obtained by the synthesis reaction (the first synthesis reaction) between diamine component and acid component in presence of azeotropic medium.

Diamine Component

The diamine component, which is used to obtain the resin component (X), comprises aromatic diamines that has a divalent aromatic group (R) having three or more aromatic rings. For example, at least one selected from the group consisting of 2,2-bis[4-(4-aminophenoxy)phenyl]propane (BAPP), bis[4-(4-aminophenoxy)phenyl]sulfone, bis[4-(4-aminophenoxy)phenyl]ether, 9,9-bis(4-aminophenyl)fluorene, 4,4′-bis(4-aminophenoxy)biphenyl, 1,4-bis(4-aminophenoxy)benzene, and isomers thereof can be used as the aromatic diamines that have the divalent aromatic group (R) having three or more aromatic rings. Note that, a residue, a divalent aromatic group, that is a group except two amino groups in the aromatic diamines corresponds to the divalent aromatic group (R) having three or more aromatic rings. Additionally, the aromatic diamines, which has divalent aromatic group (R) having three or more aromatic rings, is used as the diamine component because the composition of the aromatic diamines can decrease the abundance ratio of amide group and imide group in the polyamide-imide resin obtained finally. When the abundance ratio of amide group and imide group in the polyamide-imide decreases, dielectric constant of the polyamide-imide resin can decrease, setting partial discharge voltage high.

Acid Component

Although the acid component, which is used to obtain the resin component (X), is not especially limited if the resin component (X) is obtained by the synthesis reaction between diamine component and acid component in presence of azeotropic medium, for example, aromatic tricarboxylic anhydride or aromatic tetracarboxylic dianhydride can be used as the acid component. Specifically, trimellitic anhydride (TMA), benzophenone tricarboxylic anhydride, or the like is used as the acid component. Especially, trimellitic anhydride (TMA) is preferably used in view of cost. Note that, a mixture ratio of the diamine component and the acid component is not especially limited if the resin component (X) is obtained efficiently.

Azeotropic Medium

The synthesis reaction (the first synthesis reaction) to obtain the resin component (X) is carried out in presence of common solvent such as N-methyl-2-pyrrolidone as well as azeotropic medium. This is because water that occurs with the synthesis reaction is removed easily, and efficiency of the synthesis reaction such as imidization rate is thereby improved. Additionally, this is because compatibility between the organosol and the polyamide-imide resin obtained finally is improved effectively. Therefore, when an insulating varnish prepared by mixing the polyamide-imide resin obtained finally with organosol is used to form an insulating coating of an insulated wire or the like, the insulating coating that has a high partial discharge inception voltage and does not easily deteriorate by partial discharge can be obtained. For example, xylene, toluene, benzene, ethyl benzene, or the like is used as the azeotropic medium. Especially, xylene is preferably used in view of hazardous property and harmful property, and is preferably used to effectively provide the performance of the embodiment in the invention.

Isocyanate Component (Y)

The isocyanate component (Y), which is reacted with the resin component (X) in the synthesis reaction (the second synthesis reaction) in order to obtain the polyamide-imide resin varnish contained in the insulating varnish of the embodiment, invariably contains the diisocyanate (Y1) the molecule of which contains a bend structure. Diisocyanate that has divalent aromatic group having two aromatic rings is preferably used as the diisocyanate (Y1) the molecule of which contains the bent structure in order to improve compatibility between the resin component (X) and the diisocyanate (Y1) and compatibility between the polyamide-imide resin obtained finally and the organosol described below.

For example, 2,4′-diphenylmethane diisocyanate, 3,4′-diphenylmethane diisocyanate, 3,3′-diphenylmethane diisocyanate, 2,2′-diphenylmethane diisocyanate, 2,4′-diphenyl ether diisocyanate, or the like is used as the diisocyanate (Y1) the molecule of which contains the bend structure in the polyamide-imide resin varnish of the embodiment. The polyamide-imide resin varnish having high compatibility with the organosol can be obtained by using such isocyanate component (Y).

Additionally, the isocyanate component (Y), which is reacted with the resin component (X) in the synthesis reaction (the second synthesis reaction) in order to obtain the polyamide-imide resin varnish contained in the insulating varnish of the embodiment, may further contain the diisocyanate (Y2) the molecule of which contains a straight-chain structure. Diisocyanate that has divalent aromatic group having two aromatic rings is preferably used as the diisocyanate (Y2) the molecule of which contains the straight-chain structure. For example, 4,4′-diphenylmethane diisocyanate can be used as the diisocyanate (Y2).

Mixture Ratio of Y1 and Y2

When both the diisocyanate (Y1) whose molecule contains the bend structure and the diisocyanate (Y2) whose molecule contains the straight-chain structure are used as the isocyanate component (Y), a ratio of the diisocyanate (Y1) to the total of the diisocyanate (Y1) and the diisocyanate (Y2) is preferably in the range of 10 to 90% by mole number [{Y1/(Y1+Y2)}×100]. Furthermore, the ratio of the diisocyanate (Y1) is more preferably in the range of 25 to 90%, and is most preferably in the range of 40 to 80%. By using the insulating varnish obtained finally when the ratio of the diisocyanate (Y1) is in the range of 10 to 90%, the insulating coating that has a high partial discharge inception voltage and does not easily deteriorate can be effectively obtained. Especially, when the ratio of the diisocyanate (Y1) is in the range of 25 to 90%, the insulating coating can have both excellent flexibility and excellent softening temperature property in addition to these properties.

Synthesis Reaction (Second Synthesis Reaction) Between Resin Component (X) and isocyanate component (Y)

A method of the second synthesis reaction between the resin component (X), which has been obtained in the first synthesis reaction, and the isocyanate component (Y) is not especially limited if the polyamide-imide resin is obtained efficiently. When the isocyanate component (Y) is added to the resin component (X), for example, the diisocyanate (Y1) the molecule of which contains the bend structure is added alone to the resin component (X), or the mixture of the diisocyanate (Y1) whose molecule contains the bend structure and the diisocyanate (Y2) whose molecule contains the straight-chain structure is prepared and subsequently added to the resin component (X). The synthesis reaction is generated by the adding the isocyanate component (Y) to the resin component (X). Note that, when both the diisocyanate (Y1) whose molecule contains the bend structure and the diisocyanate (Y2) whose molecule contains the straight-chain structure are used, each of them may be added alone to the resin component (X). However, in this case, reactivity must be considered. Additionally, catalyst such as amines, imidazoles or imidazolines may be used in the second synthesis reaction, which is in order to obtain the polyamide-imide resin varnish, if it does not adversely affect stability of the varnish. Moreover, sealant such as alcohol may be used at a stop time of the second synthesis reaction. In this way, the polyamide-imide resin varnish contained in the insulating varnish of the embodiment can be obtained.

For example, when the resin component (X) described above and the isocyanate component (Y) comprising 2,4′-diphenylmethane diisocyanate as the diisocyanate (Y1) whose molecule contains the bend structure and 4,4′-diphenylmethane diisocyanate as the diisocyanate (Y2) whose molecule contains the straight-chain structure are synthesized by the method described above, polyamide-imide resin varnish having a repeat unit is obtained. The repeat unit is represented by chemical formula (I) below.

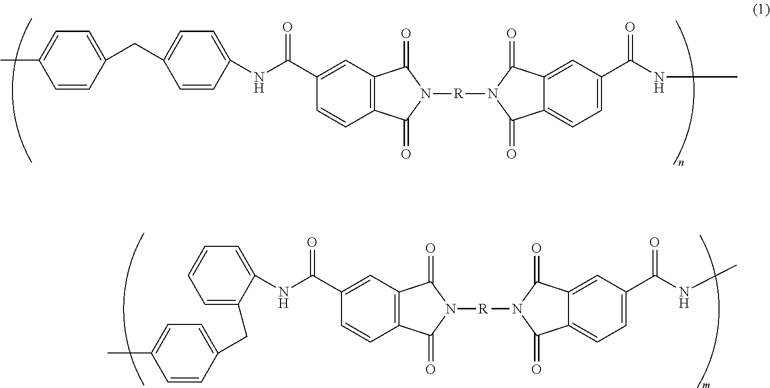

In the formula (1), “R” represents the divalent aromatic group having three or more aromatic rings. In the formula (1), “m” and “n” each represent an integer of 1 to 99.

Organosol

The organosol contained in the insulating varnish of the embodiment comprising a metallic oxide particle sol or a silicon oxide particle sol. The metallic oxide particle sol is prepared by dispersing metallic oxide particles into dispersion medium. The silicon oxide particle sol is prepared by dispersing silicon oxide particles into dispersion medium.

The insulating varnish of the embodiment preferably contains 100 parts by mass of the resin part of the polyamide-imide resin vanish and 10 to 90 parts by mass of the metallic oxide particle sol or the silicon oxide particle sol. Furthermore, the insulating varnish more preferably contains 100 parts by weight of the resin part of the polyamide-imide resin vanish and 10 to 25 parts by weight of the metallic oxide particle sol or the silicon oxide particle sol. The organosol is sol having excellent dispersibility and the property that particles do not cohere in the insulating varnish. Additionally, the organosol improves partial discharge resistance of the insulating varnish. Note that, if the metallic oxide particles or the silicon oxide particles cohere in the insulating varnish, viscosity of the insulating varnish may increase, and partial discharge resistance of the insulating varnish may decrease because of imparted thixotropic nature, etc.

For example, alumina particle sol, zirconia particle sol, titania particle sol, yttria particle sol, or the like is used as the metallic oxide particle sol, which composes the organosol for obtaining the insulating varnish of the embodiment. For example, silica particle sol is used as the silicon oxide particle sol. Additionally, solvent substitution may be carried out in these sols.

Note that, when silica particle sol prepared by dispersing silica particles into dispersion medium is used as the organosol, hydrophobic silica particles can be effectively used as the silica particles in view of compatibility with the polyamide-imide resin varnish.

Organosol in which metallic oxide particles or silicon oxide particles of 100 nm or less in average particle diameter disperse in dispersion medium is preferably used as the organosol of the present embodiment in view of compatibility with the polyamide-imide resin varnish. When hydrophobic silica particles are used as the silicon oxide particles, average particle diameter of the hydrophobic silica particles is preferably 30 nm or less.

For example, water, methanol, dimethylacetamide, methyl ethyl isobutyl ketone, xylene/butanol combined solvent, gamma-butyrolactone, or the like is used as the dispersion medium for metallic oxide particle sol or silicon oxide particle sol.

The insulating varnish of the embodiment is obtained by dispersing the polyamide-imide resin varnish and the organosol described above. By forming the insulating coating by using the insulating varnish, the insulating coating can have higher partial discharge inception voltage (e.g. 950 Vp or more) than conventional one, and dielectric breakdown due to depletion of the insulating coating can be suppressed even if high inverter surge voltage occur.

Insulated Wire and Method of Forming the Same

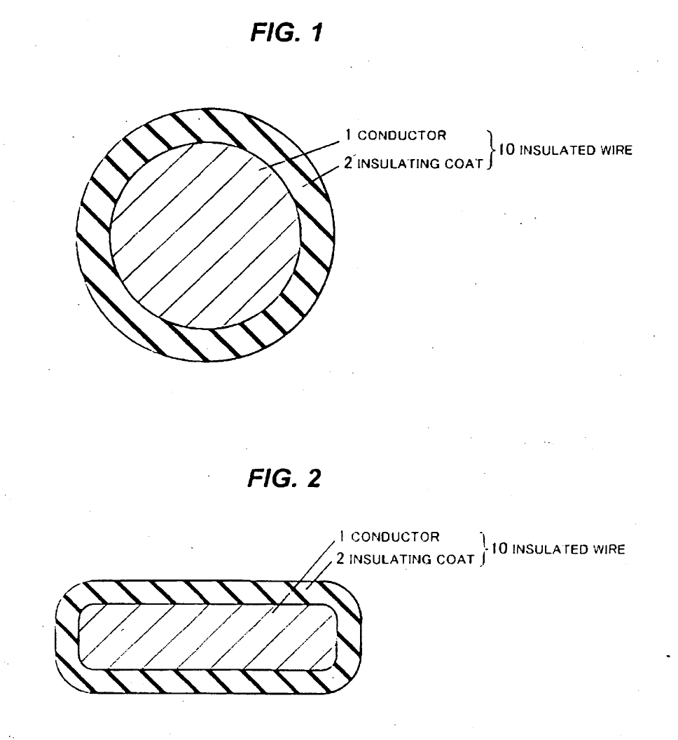

As shown in FIGS. 1 and 2, the insulated wire 10 of the embodiment has conductor 1 and the insulating coating 2. The conductor has a round or rectangular cross section. The insulating coating 2 is formed by applying and baking the insulating varnish described above on surface of the conductor 1. The insulating coating 2, which is formed by using the insulating varnish described above, preferably has 20 μm or more thickness. When the thickness is less than 20 μm, although the insulating coating 2 has excellent heat resistance and excellent abrasion resistance, it is difficult that the insulating coating 2 has high partial discharge inception voltage. Note that, it is preferred that relative dielectric constant of the insulating coating 2 is as low as possible. The relative dielectric constant of 3.0 or less is effective to increase partial discharge inception voltage.

The insulated wire 10 of the embodiment may have an adhesion-imparting insulating coating, a flexibility-imparting insulating coating, or the like between the conductor 1 and the insulating coating 2. The adhesion-imparting insulating coating is an insulating coating for increasing adhesion between the conductor 1 and the insulating coating 2. The flexibility-imparting insulating coating is an insulating coating for increasing flexibility of the insulated wire. Additionally, the insulated wire 10 of the embodiment may have a lubricity-imparting insulating coating for improving lubricity, a scratch resistance-imparting insulating coating for improving scratch resistance, or the like around the insulating coating 12. The adhesion-imparting insulating coating, the flexibility-imparting insulating coating, the lubricity-imparting insulating coating, and the scratch resistance-imparting insulating coating may be formed by applying and baking the insulating varnish or by extrusion molding with an extruder.

Additionally, in the insulated wire 10 of the embodiment, a single-layered or multi-layered organic insulating coating may be formed between the conductor 1 and the insulating coating 2. The organic insulating coating is formed by applying and baking insulating varnish that is formed by dispersing resin comprising a polyimide, a polyamide-imide, a polyesterimide, a class-H polyester or the like into a solvent.

The conductor 1 used for the insulated wire 10 of the embodiment comprises a copper conductor. An oxygen-free copper or oxygen-less copper is mainly used as the copper conductor. Note that, the copper conductor is not limited to them, for example, a conductor formed by applying metal plating to a surface of copper can be used. Additionally, a conductor having a cross-section such as a round cross-section or a rectangular cross-section is used as the conductor 1. Here, the rectangular cross-section implies substantial rectangular cross-section having rounded corners shown as FIG. 2.

### EXAMPLES

Polyamide-imide resin varnishes in examples of the embodiment and in comparative examples have been formed by the following methods.

Synthesis of Polyamide-Imide Resin Varnish (A)

First, 446.5 g of 2,2-bis[4-(4-aminophenoxy)phenyl]propane (BAPP) and 449.2 g of trimellitic anhydride (TMA) were mixed in a flask having a stirring machine, a return current cooling pipe, a nitrogen inhalant canal and a thermometer. Next, 2515.9 g of N-methyl-2-pyrrolidone as solvent and 252 g of xylene as azeotropic medium were added into the flask. Next, these were reacted for 6 hour under a condition in which a stirring rotation frequency, a nitrogen flow rate, and temperature in the system are respectively 180 rpm, 1 L/min, and 180° C. The reaction proceeded while water and xylene generated during dehydration reaction were being discharged out of the system, a resin component (X) was thereby obtained. Then, after the obtained resin component (X) was cooled to 90° C., 313.4 g of an isocyanate component (Y) and the resin component (X) was mixed and reacted for 4 hour under a condition in which a stirring rotation frequency, a nitrogen flow rate, and temperature in the system are respectively 150 rpm, 0.1 L/min, and 140° C. Here, the isocyanate component (Y) was prepared by mixing 2,4′-diphenylmethane diisocyanate (Y1) and 4,4′-diphenylmethane diisocyanate (Y2) in a 50:50 molar ratio. In other words, the ratio of the 2,4′-diphenylmethane diisocyanate (Y1) in the total of the 2,4′-diphenylmethane diisocyanate (Y1) and the 4,4′-diphenylmethane diisocyanate (Y2) was 50% by mole number. After that, 88.4 g of benzyl alcohol and 628.9 g of N,N-dimethylformamide were added for termination reaction. As a result, polyamide-imide resin varnish (A) whose viscosity measured with an E-type viscometer is in the range of about 2000 to 3000 mPa·s was obtained.

Synthesis of Polyamide-Imide Resin Varnish (B)

First, 446.5 g of 2,2-bis[4-(4-aminophenoxy)phenyl]propane (BAPP) and 449.2 g of trimellitic anhydride (TMA) were mixed in a flask having a stirring machine, a return current cooling pipe, a nitrogen inhalant canal and a thermometer. Next, 2515.9 g of N-methyl-2-pyrrolidone as solvent and 252 g of xylene as azeotropic medium were added into the flask. Next, these were reacted for 6 hour under a condition in which a stirring rotation frequency, a nitrogen flow rate, and temperature in the system are respectively 180 rpm, 1 L/min, and 180° C. The reaction proceeded while water and xylene generated during dehydration reaction were being discharged out of the system, a resin component (X) was thereby obtained. Then, after the obtained resin component (X) was cooled to 90° C., 316.4 g of an isocyanate component (Y) and the resin component (X) was mixed and reacted for 4 hour under a condition in which a stirring rotation frequency, a nitrogen flow rate, and temperature in the system are respectively 150 rpm, 0.1 L/min, and 140° C. Here, the isocyanate component (Y) includes 2,4′-diphenylmethane diisocyanate. After that, 88.4 g of benzyl alcohol and 628.9 g of N,N-dimethylformamide were added for termination reaction. As a result, polyamide-imide resin varnish (B) whose viscosity measured with an E-type viscometer is in the range of about 2000 to 3000 mPa·s was obtained.

Synthesis of Polyamide-Imide Resin Varnish (C)

First, 446.5 g of 2,2-bis[4-(4-aminophenoxy)phenyl]propane (BAPP) and 449.2 g of trimellitic anhydride (TMA) were mixed in a flask having a stirring machine, a return current cooling pipe, a nitrogen inhalant canal and a thermometer. Next, 2515.9 g of N-methyl-2-pyrrolidone as solvent and 252 g of xylene as azeotropic medium were added into the flask. Next, these were reacted for 6 hour under a condition in which a stirring rotation frequency, a nitrogen flow rate, and temperature in the system are respectively 180 rpm, 1 L/min, and 180° C. The reaction proceeded while water and xylene generated during dehydration reaction ware being discharged out of the system, a resin component (X) was thereby obtained. Then, after the obtained resin component (X) was cooled to 90° C., 316.4 g of an isocyanate component (Y) and the resin component (X) was mixed and reacted for 4 hour under a condition in which a stirring rotation frequency, a nitrogen flow rate, and temperature in the system are respectively 150 rpm, 0.1 L/min, and 140° C. Here, the isocyanate component (Y) includes 4,4′-diphenylmethane diisocyanate. After that, 88.4 g of benzyl alcohol and 628.9 g of N,N-dimethylformamide were added for termination reaction. As a result, polyamide-imide resin varnish (C) whose viscosity measured with an E-type viscometer is in the range of about 2000 to 3000 mPa·s was obtained.

Synthesis of Polyamide-Imide Resin Varnish (D)

First, 446.5 g of 2,2-bis[4-(4-aminophenoxy)phenyl]propane (BAPP) and 449.2 g of trimellitic anhydride (TMA) were mixed in a flask having a stirring machine, a return current cooling pipe, a nitrogen inhalant canal and a thermometer. Next, 2515.9 g of N-methyl-2-pyrrolidone as solvent and 252 g of xylene as azeotropic medium were added into the flask. Next, these were reacted for 6 hour under a condition in which a stirring rotation frequency, a nitrogen flow rate, and temperature in the system are respectively 180 rpm, 1 L/min, and 180° C. The reaction proceeded while water and xylene generated during dehydration reaction were being discharged out of the system, a resin component (X) was thereby obtained. Then, after the obtained resin component (X) was cooled to 90° C., 313.4 g of an isocyanate component (Y) and the resin component (X) was mixed and reacted for, 4 hour under a condition in which a stirring rotation frequency, a nitrogen flow rate, and temperature in the system are respectively 150 rpm, 0.1 L/min, and 140° C. Here, the isocyanate component (Y) was prepared by mixing 2,4′-diphenylmethane diisocyanate (Y1) and 4,4′-diphenylmethane diisocyanate (Y2) in a 10:90 molar ratio. In other words, the ratio of the 2,4′-diphenylmethane diisocyanate (Y1) in the total of the 2,4′-diphenylmethane diisocyanate (Y1) and the 4,4′-diphenylmethane diisocyanate (Y2) was 10% by mole number. After that, 88.4 g of benzyl alcohol and 628.9 g of N,N-dimethylformamide were added for termination reaction. As a result, polyamide-imide resin varnish (D) whose viscosity measured with an E-type viscometer is in the range of about 2000 to 3000 mPa·s was obtained.

Synthesis of Polyamide-Imide Resin Varnish (E)

First, 446.5 g of 2,2-bis[4-(4-aminophenoxy)phenyl]propane (BAPP) and 449.2 g of trimellitic anhydride (TMA) were mixed in a flask having a stirring machine, a return current cooling pipe, a nitrogen inhalant canal and a thermometer. Next, 2515.9 g of N-methyl-2-pyrrolidone as solvent and 252 g of xylene as azeotropic medium were added into the flask. Next, these were reacted for 6 hour under a condition in which a stirring rotation frequency, a nitrogen flow rate, and temperature in the system are respectively 180 rpm, 1 L/min, and 180° C. The reaction proceeded while water and xylene generated during dehydration reaction were being discharged out of the system, a resin component (X) was thereby obtained. Then, after the obtained resin component (X) was cooled to 90° C., 313.4 g of an isocyanate component (Y) and the resin component (X) was mixed and reacted for 4 hour under a condition in which a stirring rotation frequency, a nitrogen flow rate, and temperature in the system are respectively 150 rpm, 0.1 L/min, and 140° C. Here, the isocyanate component (Y) was prepared by mixing 2,4′-diphenylmethane diisocyanate (Y1) and 4,4′-diphenylmethane diisocyanate (Y2) in a 90:10 molar ratio. In other words, the ratio of the 2,4′-diphenylmethane diisocyanate (Y1) in the total of the 2,4′-diphenylmethane diisocyanate (Y1) and the 4,4′-diphenylmethane diisocyanate (Y2) was 90% by mole number. After that, 88.4 g of benzyl alcohol and 628.9 g of N,N-dimethylformamide were added for termination reaction. As a result, polyamide-imide resin varnish (E) whose viscosity measured with an E-type viscometer is in the range of about 2000 to 3000 mPa·s was obtained.

### Example 1

Silica particle sol containing 10 parts by mass of silica component was dispersed into the polyamide-imide resin varnish (A) relative to 100 parts by mass of the resin part of the polyamide-imide resin vanish (A) while the polyamide-imide resin varnish (A) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 1 was obtained.

### Example 2

Silica particle sol containing 90 parts by mass of silica component was dispersed into the polyamide-imide resin varnish (A) containing 100 parts by mass of the resin component (X) while the polyamide-imide resin varnish (A) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 2 was obtained.

### Example 3

Silica particle sol containing 10 parts by mass of silica component was dispersed into the polyamide-imide resin varnish (B) containing 100 parts by mass of the resin component (X) while the polyamide-imide resin varnish (B) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 3 was obtained.

### Example 4

Silica particle sol containing 90 parts by mass of silica component was dispersed into the polyamide-imide resin varnish (B) containing 100 parts by mass of the resin component (X) while the polyamide-imide resin varnish (B) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 4 was obtained.

### Example 5

Silica particle sol containing 110 parts by mass of silica component was dispersed into the polyamide-imide resin varnish (A) containing 100 parts by mass of the resin component (X) while the polyamide-imide resin varnish (A) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 5 was obtained.

### Example 6

Silica particle sol containing 15 parts by mass of silica component was dispersed into the polyamide-imide resin varnish (A) containing 100 parts by mass of the resin component (X) while the polyamide-imide resin varnish (A) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 6 was obtained.

### Example 7

Silica particle sol containing 85 parts by mass of silica component was dispersed into the polyamide-imide resin varnish (A) containing 100 parts by mass of the resin component (X) while the polyamide-imide resin varnish (A) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 7 was obtained.

### Example 8

Silica particle sol containing 50 parts by mass of silica component was dispersed into the polyamide-imide resin varnish (D) containing 100 parts by mass of the resin component (X) while the polyamide-imide resin varnish (D) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 8 was obtained.

### Example 9

Silica particle sol containing 50 parts by mass of silica component was dispersed into the polyamide-imide resin varnish (E) relative to 100 parts by mass of the resin part of the polyamide-imide resin varnish (E) while the polyamide-imide resin varnish (E) was being stirred, insulating varnish was thereby obtained. Here, dispersion medium and dispersion particles of the silica particle sol were respectively gamma-butyrolactone and silica particles having an average diameter of 12 nm. Then, applying and baking of the insulating varnish on a copper wire having diameter of 0.80 mm were repeated so that an insulating coating was formed in thickness of 0.045 mm. As a result, an insulated wire in example 9 was obtained.

### Comparative Example 1

Applying and baking of the polyamide-imide resin varnish (A) on a copper wire having diameter of 0.80 mm were repeated so that an insulating coating was formed in thickness of 0.045 mm. As a result, an insulated wire in comparative example 1 was obtained.

### Comparative Example 2

Applying and baking of the polyamide-imide resin varnish (B) on a copper wire having diameter of 0.80 mm were repeated so that an insulating coating was formed in thickness of 0.045 mm. As a result, an insulated wire in comparative example 2 was obtained.

### Comparative Example 3

Applying and baking of the polyamide-imide resin varnish (C) on a copper wire having diameter of 0.80 mm were repeated so that an insulating coating was formed in thickness of 0.045 mm. As a result, an insulated wire in comparative example 3 was obtained.

### Comparative Example 4

Silica particle sol containing 90 parts by mass of silica component was dispersed into the polyamide-imide resin varnish (C) relative to 100 parts by mass of the resin part of the polyamide-imide resin varnish (C) while the polyamide-imide resin varnish (C) was being stirred, insulating varnish was thereby obtained. Here, dispersion medium and dispersion particles of the silica particle sol were respectively gamma-butyrolactone and silica particles having an average diameter of 12 nm. However, the insulating varnish could not be applied and baked on a copper wire because the silica component was deposited to make the insulating varnish cloudy.

The following test for the insulated wires formed by using the insulating varnishes in the examples 1 to 9 and the comparative examples 1 to 3 was conducted.

The formed insulated wire was buried in a resin in order to be fixed, and the cross sections of the ends of the insulated wire buried in the resin were polished together with the resin. A diameter of the copper conductor, a thickness of the insulating coating, and an overall diameter of the insulated wire were measured at the cross sections exposed by the polishing.

Measurement of Partial Discharge Inception Voltage (PDIV)

A partial discharge inception voltage was measured through following steps. First, the insulated wire was cut in length of 500 mm. Next, ten twisted pair wires were made of the cut insulated wire. Next, portions of 10 mm in length at the ends of the insulating coating of each of the twisted pair wires were removed to form terminal-treated portions. Next, the PDIV was measured by using a partial discharge automatic test system, such that electrodes were connected with the terminal-treated portions, and voltage of 50 Hz was applied to the twisted pair wires in the atmosphere that a temperature was 25° C. and humidity was 50%. Here, the voltage was increased at a rate of 10-30 V/s to a voltage at which discharge of 10 pC occurs 50 times per second. This process was repeated three times, and then the average of the three voltages, at which discharge of 10 pC occurs 50 times, was defined as the partial discharge inception voltage.

Evaluation of Surge Resistance

An inverter phase-to-phase voltage of 1000 Vp class was applied between the two insulated wires wound parallel so as to form coil under test, and then time until breakdown was measured. The insulated wire in which time until breakdown was 1100 hour or more was classified as “⊚” (fine), the insulated wire in which time until breakdown was not less than 1000 hour and less than 1100 hour was classified as “◯” (accepted), and the insulated wire in which time until breakdown was less than 1000 hour was classified as “x” (rejected).

Evaluation of Flexibility

First, the insulated wires not elongated in a length direction and the insulated wires elongated 20% longer than the insulated wires not elongated were prepared. Next, each of these wires is wound around one of round bars (winding bars) having a smooth surface so as to form 5 coils. Here, each of the round bars has a diameter 1-10 times that of the copper wire, and 5 rolls of the insulated wire around the round bar is equivalent to 1 coil. Then, a minimum winding diameter (d) was measured by an optical microscope. The minimum winding diameter (d) was defined as a minimum winding diameter when occurrence of cracks was not observed on the insulating coating at the time of winding.

Twisting Test

First, the insulated wire was fixed linearly between two clamps located at a distance of 250 mm. Then, one clamp was rotated, and the number of rotation at the time that the insulating coating was separated from the copper wire was measured. Here, rotation of 360° corresponds to 1 rotation.

Evaluation of Softening Temperature

First, two insulated wires of 120 mm in length were prepared. Next, one end portion of the insulating coating of each of the insulated wire was removed, and an electrode was connected to the exposed portion of the copper wire of each of the insulated wire. Next, the wires were crisscrossed and attached to a softening resistance test machine, K7800 manufactured by Totoku Toryo Co., Ltd., under a load of 6.9 N (0.7 kgf). Then, the temperature was increased at a rate of 0.1° C./min while a voltage was applied between the electrodes, and a temperature when conduction between the insulated wires was detected was defined as a softening temperature.

The measurement results and the evaluation results for the insulated wires in the examples and the comparative examples are shown in Table 1.

TABLE 1

| Items | | | Example 1 | Example 2 | Example 3 | Example 4 | Example 5 | Example 6 | Example 7 | Example 8 |
|---|---|---|---|---|---|---|---|---|---|---|
| Properties of | Kind of polyamide-imide resin | | A | A | B | B | A | A | A | D |
| insulating | 2.4-MDI/4.4-MDI (Mole ratio) | | 50/50 | 50/50 | 100/0 | 100/0 | 50/50 | 50/50 | 50/50 | 10/90 |
| varnish | Amount of polyamide-imide resin | | 100 | 100 | 100 | 100 | 100 | 100 | 100 | 100 |
| | (parts by mass) | | | | | | | | | |
| | Amount of silica sol (parts by mass) | | 10 | 90 | 10 | 90 | 110 | 15 | 85 | 50 |
| | Appearance | | No | No | No | No | No | No | No | No |
| | | | turbidity | turbidity | turbidity | turbidity | turbidity | turbidity | turbidity | turbidity |
| | Stability in storage (at 25° C.) | | No | No | No | No | No | No | No | No |
| | | | turbidity | turbidity | turbidity | turbidity | turbidity | turbidity | turbidity | turbidity |
| Properties of | Flexibility | no elongation | 1d | 1d | 1d | 1d | 1d | 1d | 1d | 1d |
| insulated | | 20% elongation | 1d | 4d | 1d | 4d | 4d | 1d | 4d | 3d |
| wire | Twisting Test | (Number of times) | 140 | 116 | 145 | 122 | 110 | 138 | 118 | 135 |
| | Softening | (° C.) | 434 | 436 | 430 | 432 | 437 | 434 | 436 | 440 |
| | temperature | | | | | | | | | |
| | Partial discharge | (Vp) | 990 | 980 | 980 | 980 | 975 | 990 | 980 | 980 |
| | starting voltage | 25° C. - 50% RH | | | | | | | | |
| | | (detection sensitivity | | | | | | | | |
| | | with 50 Hz voltage | | | | | | | | |
| | | is 10 pC) | | | | | | | | |
| | surge resistance | with applied voltage | ◯ | ⊚ | ◯ | ⊚ | ⊚ | ◯ | ⊚ | ◯ |
| | | of 1000 Vp | | | | | | | | |

| | | | | Comparative | Comparative | Comparative | Comparative |
|---|---|---|---|---|---|---|---|
| Items | | | Example 9 | Example 1 | Example 2 | Example 3 | Example 4 |
| Properties of | Kind of polyamide-imide resin | | E | A | B | C | C |
| insulating | 2.4-MDI/4.4-MDI (Mole ratio) | | 90/10 | 50/50 | 100/0 | 0/100 | 0/100 |
| varnish | Amount of polyamide-imide resin | | 100 | 100 | 100 | 100 | 100 |
| | (parts by mass) | | | | | | |
| | Amount of silica sol (parts by mass) | | 50 | 0 | 0 | 0 | 90 |
| | Appearance | | No | No turbidity | No turbidity | No turbidity | turbidity |
| | | | turbidity | | | | |
| | Stability in storage (at 25° C.) | | No | No turbidity | No turbidity | No turbidity | turbidity |
| | | | turbidity | | | | |
| Properties of | Flexibility | no elongation | 1d | 1d | 1d | 1d | — |
| insulated | | 20% elongation | 1d | 1d | 1d | 1d | — |
| wire | Twisting Test | (Number of times) | 139 | 139 | 145 | 136 | — |
| | Softening | (° C.) | 430 | 433 | 428 | 441 | — |
| | temperature | | | | | | |
| | Partial discharge | (Vp) | 980 | 995 | 990 | 990 | — |
| | starting voltage | 25° C. - 50% RH | | | | | |
| | | (detection sensitivity | | | | | |
| | | with 50 Hz voltage | | | | | |
| | | is 10 pC) | | | | | |
| | surge resistance | with applied voltage | ◯ | X | X | X | — |
| | | of 1000 Vp | | | | | |

As shown in Table 1, in the embodiments 1 to 9, the insulated wires, which had high partial discharge inception voltages of 950Vp or more and in which dielectric breakdown did not occur for over 1000 hour even though the very high inverter surge voltage was applied, was obtained. On the other hand, the insulated wire of the comparative example 1 had a high partial discharge inception voltages (Vp) of 995 V, but the surge resistance thereof was low when the inverter phase-to-phase voltage (Vp) of 1000 V class was applied. In addition, the insulated wires of the comparative examples 2 and 3 had the partial discharge inception voltages (Vp) of 995 V or more, but the surge resistance thereof was low like the insulated wire of the comparative example 1.

As described above, the insulating varnish, which is used to form an insulating coating that has a high partial discharge inception voltage as well as the property that dielectric breakdown does not occur easily even if inverter surge voltage occurs, and the insulated wire formed by using the insulating varnish can be obtained. The insulating coating is formed by applying and baking the insulating varnish on a conductor. The insulating varnish is prepared by mixing polyamide-imide resin varnish with organosol. The polyamide-imide resin varnish comprises a solvent and a polyamide-imide resin. The polyamide-imide resin varnish is obtained by a synthesis reaction between resin component (X) and isocyanate component (Y). The resin component (X) is obtained by a synthesis reaction between a diamine component and an acid component in presence of an azeotropic medium. The diamine component comprises aromatic diamines that have a divalent aromatic group having three or more aromatic rings. The isocyanate component (Y) includes the diisocyanate (Y1) whose molecule contains the bend structure.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An insulating varnish, comprising:
a polyamide-imide resin varnish comprising a solvent and a polyamide-imide resin; and
an organosol,
wherein the polyamide-imide resin varnish is obtained by a synthesis reaction between a resin component (X) and an isocyanate component (Y),
the resin component (X) is obtained by a synthesis reaction between a diamine component and an acid component in presence of an azeotropic medium,
the diamine component comprises aromatic diamines comprising a divalent aromatic group having three or more aromatic rings, and
the isocyanate component (Y) comprises a diisocyanate (Y1) a molecule of which includes a bend structure.

2. The insulating varnish according to claim 1, wherein the isocyanate component (Y) further comprises a diisocyanate (Y2) a molecule of which includes a straight-chain structure.

3. The insulating varnish according to claim 2, wherein a ratio of the diisocyanate (Y1) to a total of the diisocyanate (Y1) and the diisocyanate (Y2) is in a range of 10 to 90% by mole percent [{Y1/(Y1+Y2)}×100].

4. The insulating varnish according to claim 1, wherein the diisocyanate (Y1) comprises 2,4′-diphenyl methane diisocyanate, 3,4′-diphenylmethane diisocyanate, 3,3′-diphenylmethane diisocyanate, or 2,2′-diphenylmethane diisocyanate, 2,4′-diphenyl ether diisocyanate.

5. The insulating varnish according to claim 1, wherein the polyamide-imide resin varnish is obtained by a synthesis reaction between the resin component (X) and the isocyanate component (Y) comprising 2,4′-diphenylmethane diisocyanate and 4,4′-diphenylmethane diisocyanate, and
the polyamide-imide resin varnish comprises a repeat unit represented by chemical formula (1): 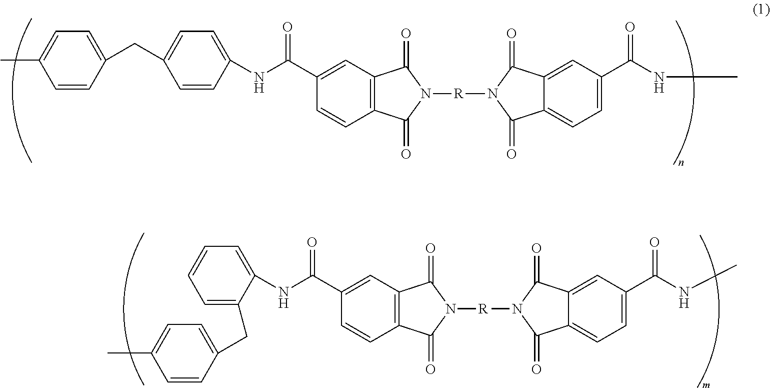
where “R” represents the divalent aromatic group having three or more aromatic rings, and “m” and “n” each represent an integer of 1 to 99.

6. The insulating varnish according to claim 1, wherein the aromatic diamines comprise at least one selected from the group consisting of 2,2-bis[4-(4-aminophenoxy)phenyl]propane (BAPP), bis[4-(4-aminophenoxy)phenyl]sulfone, bis[4-(4-aminophenoxy)phenyl]ether, 9,9-bis(4-aminophenyl)fluorene, 4,4′-bis(4-aminophenoxy)biphenyl, 1,4-bis(4-aminophenoxy)benzene, and isomers thereof.

7. The insulating varnish according to claim 1, wherein the azeotropic medium comprises xylene.

8. The insulating varnish according to claim 1, wherein 10 to 90 parts by mass of the organosol are included relative to 100 parts by mass of the polyamide-imide resin.

9. An insulated wire, comprising:
a conductor; and
an insulating coating formed by applying and baking the insulating varnish according to claim 1 on the conductor.

10. The insulated wire according to claim 9, wherein the conductor has a rectangular cross section.
